(19) United States
(12) Patent Application Publication
(10) Pub. No.: US 2008/0014313 A1
(43) Pub. Date: Jan. 17, 2008

(54) WINE SEMINAR PACKAGE

(76) Inventor: Paul Squicciariny, Rancho Santa Margarita, CA (US)

Correspondence Address: HUGH P. GORTLER, 23 ARRIVO DRIVE, MISSION VIEJO, CA, 92692, US

(21) Appl. No.: 11/457,447

(22) Filed: Jul. 13, 2006

(51) Int. Cl. A23B 7/148

(52) U.S. Cl. 426/106

(57) ABSTRACT

A wine seminar package includes an individual-sized box and a plurality of containers arranged for presentation inside the box. The containers contain components for distinguishing the taste structure of wine. The containers within the box are arranged to allow a person to participate in a wine seminar.

### BACKGROUND

Seminars are held to educate customers about various aspects of wine. One aspect involves the taste structure of wine: the basic taste components in wine and how they relate to the balance and harmony of wine. The seminar can identify thresholds of taste and locations within the mouth and where tastes are concentrated. The seminar can also help customers establish a common recognition of the taste structure of wine.

Taste refers to the four taste senses and where they are located in the mouth. Sweet tastes (e.g., sugar) are sensed at the tip of the tongue, sour tastes (e.g., acid) are sensed along front edges of tongue, and bitter tastes (e.g., tannin) are sensed at the center and back of the tongue and mouth. The fourth taste, salt, is usually not a concern of wine making, but it can have an impact on wine taste and selection.

During a typical seminar, the recognition of a wine's taste structure can be taught by allowing customers to taste the wine and compare it to samples that are too sweet, too bitter, too acidic, and so on.

Setting up for the typical seminar can be time consuming. Typically, containers with the different samples are arranged on a table for each attendee. The samples are usually prepared during setup. Also during setup, other elements are arranged on the table for each attendee (e.g., wine tasting glasses, crackers for palette cleaning, a cup for discarding tasted samples, a pen and pad for taking notes, educational items). It isn't unusual for setup to take a few hours.

Procuring the various items for the typical seminar can also be time consuming. The various items might have to be sourced and purchased from many different vendors.

### BRIEF DESCRIPTION OF THE DRAWINGS

FIG. 1 is an illustration of a wine seminar package according to an embodiment of the present invention.

FIG. 2 is an illustration of a tray for the package according to an embodiment of the present invention.

FIG. 3 is an illustration of a method according to an embodiment of the present invention.

### DETAILED DESCRIPTION

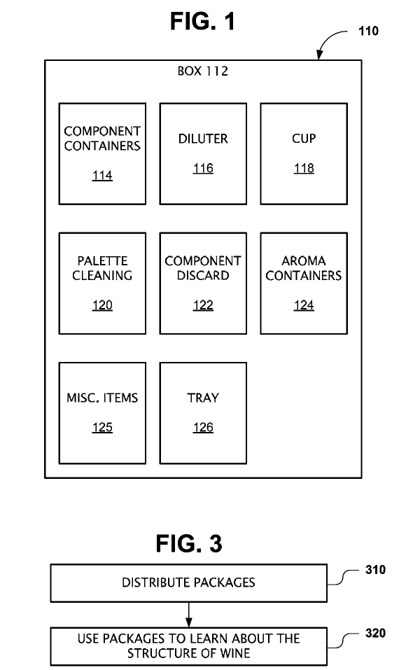

Reference is made to FIG. 1, which illustrates a package 110 for enabling a person to learn about the taste structure of wine. The package 110 includes an individual-sized box 112 and a plurality of component containers 114 inside the box 112. An exemplary box size is roughly 15″×9″×3″.

The containers 114 contain components for distinguishing the taste structure of wine. The taste structure of the wine refers to at least one of acidity, tanning, sugar level, alcohol level, etc. The taste structure of wine does not encompass the aroma and flavor of wine.

The components in the containers 114 are not limited to any particular type, number or combination. Exemplary components for distinguishing the structure of wine include, without limitation, sugar for distinguishing sweet taste, citric acid for sour taste, and tannic acid for bitter taste.

The component containers 114 are arranged for presentation within the box 112. That is, the containers 114 are arranged in a way that makes it easier for a person to participate in a wine seminar. For example, the component containers 114 sit upright in the box 112 as opposed to lying on their sides, and the component containers 114 are arranged in a certain order (for example, each column has the same components, under-diluted components are in a first row, over-diluted components are in a second row).

The components within the containers 114 may be diluted or undiluted. As a first example, the components could be diluted a few hours prior to the seminar. As a second example, the components could be diluted during the seminar, either by presenter or student.

The box 112 may contain other items for allowing a person to participate in a wine seminar. For instance, the box 112 may include a diluter 116 for diluting some of the components during the seminar. Water may be used as a diluter 116. Water is very neutral in taste so the components can be tasted without any other taste or flavor interference. It will be the only component that is perceived, thus allowing a common recognition of individual taste to be established.

The component containers 114 may have measurement gradations. The gradations indicate the correct level of liquid that should be added to the component containers 114.

The box 112 may include a wine cup or glass 118. The box 112 may also include miscellaneous items 125 such as a liquid dropper. The dropper may be used to remove wine from the glass 118 and add the wine to some of the component containers 114.

The box 112 may include a means 120 for palette cleaning. Crackers, for example, may be used for palette cleaning.

The box 112 may include a means 122 for discarding diluted components that have been tasted. During the seminar, the diluted components are typically sipped and swished around the inside of the mouth and palette, and then spit out. The tasted components may be discarded into means 122 such as paper cups.

The miscellaneous items 125 may also include educational items such as pamphlets and fact sheets. The educational items may be inserted in the box 112.

The taste of a wine is one element of the wine's flavor. Another element is aroma. The box 112 may also include additional containers 124 for distinguishing the aroma of wine. These additional containers 124 might contain scented oils that have aromas found in wine. Examples include apple, orange, lemon scented oils. The contents of these additional containers 124 do not have to be diluted.

A tray 126 may be used for presenting the contents of the box 112. The tray 126 may be partly or fully removable from the box 112, or it may be fixed within the box 112.

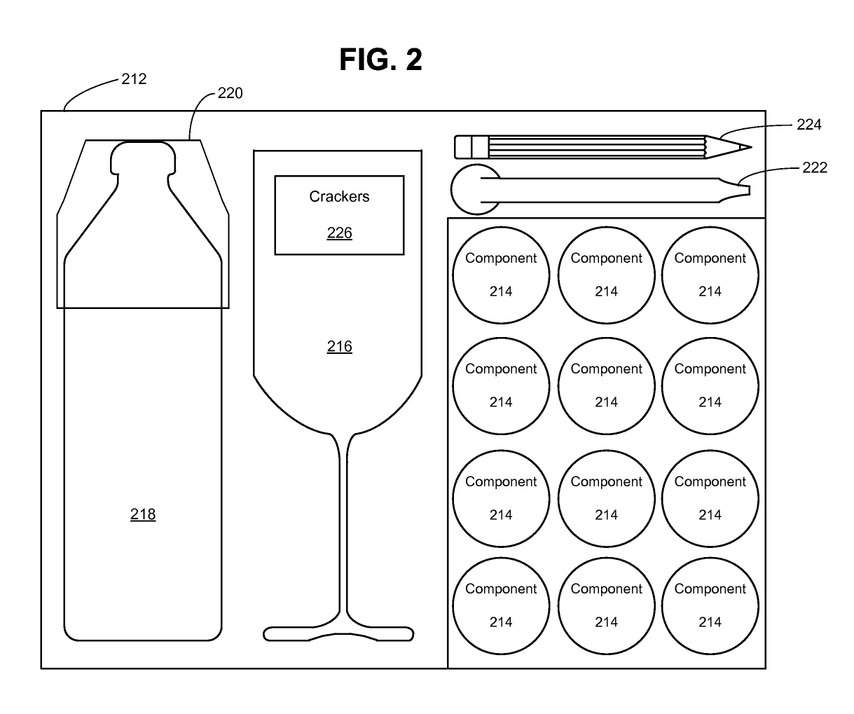

Reference is now made to FIG. 2, which illustrates an exemplary tray 210 for the package. The tray 210 includes a platform 212 with a set of cut-outs 214 for the component containers. These cut-outs 214 allow the component containers to sit upright within the box 112. The tray 210 also includes a cut-out 216 for a wine cup, a cut-out 218 for a bottle of water, a cut-out 220 for a cup, a cut-out 222 for a liquid dropper, and a cut-out 224 for a pencil. Crackers can be stored in the wine glass are placed within its own cutout 226.

Reference is now made to FIG. 3, which illustrates an exemplary method of using wine seminar packages 110 to educate attendees about wine. The packages are distributed at the seminar, before or during a presentation (block 310).

During the presentation, the attendees are instructed to use their packages to learn about the taste structure of wine (block 320). As an example, the attendees are instructed to open their packages, fill their glasses with wine, over-dilute the components in a first set of component containers (e.g., by adding water to the appropriate level), under-dilute the components in a second set of component containers, add wine to a third set of component containers, put lids on the component containers, and shake all of the component containers. Thus, the first set contains what is considered a low amount of component in wine; the second set contains what is considered a high amount of component in wine; and the third set contains what is considered an out-of-balance wine. After the component containers have been shaken, the attendees are instructed to compare the wine in the glass to the contents of the different component containers. Palette cleaning may be performed at various times.

The tray can be labeled to identify both component and concentration of component. Thus, the tray helps to organize the component containers and avoid confusion. An added advantage of the tray is that it can be used to shake the component containers simultaneously.

As for setup, there is no need to place component containers, wine glasses, water bottles and other components on tables prior to the seminar. Setup consists solely of distributing the packages 110. Moreover, the packages are distributed only to people who actually attend the seminar. Time is not wasted setting up for no-shows. As a result, setup time is reduced dramatically.

Cleanup time is also reduced. There is no need to gather unused components at empty seats.

Although specific embodiments of the present invention have been described and illustrated, the present invention is not limited to the specific forms or arrangements of parts so described and illustrated. Instead, the present invention is construed according to the following claims.

1. A wine seminar package comprising an individual-sized box and a plurality of containers arranged for presentation inside the box, the containers containing components for distinguishing the taste structure of wine, the containers arranged to allow a person to participate in a wine seminar.

2. The package of claim 1, wherein the components are diluted.

3. The package of claim 1, wherein the components are not diluted.

4. The package of claim 1, further comprising means within the box for diluting the components.

5. The package of claim 1, further comprising means within the box for palette cleaning.

6. The package of claim 1, further comprising means within the box for discarding tasted components.

7. The package of claim 1, further comprising a removable tray inside the box for arranging the containers for presentation.

8. The package of claim 7, wherein the tray includes a platform with cut-outs for the containers.

9. The package of claim 1, further comprising components for distinguishing the aroma and flavor of wine.

10. A method of educating seminar attendees about wine, the method comprising pre-preparing a plurality of components that distinguish the structure of wine; and arranging the components in boxes for presentation at the seminar, whereby the boxes will be distributed to the attendees at the seminar.
